(19) United States
(12) Patent Application Publication
(10) Pub. No.: US 2021/0372042 A1
(43) Pub. Date: Dec. 2, 2021

(54) CARPET AND METHOD OF MAKING SAME WITHOUT LATEX PRECOAT

(71) Applicant: COLUMBIA INSURANCE COMPANY, Omaha, NE (US)

(72) Inventors: Kurt Allan Kniss, Calhoun, GA (US); Steven Dunkle, Dalton, GA (US)

(21) Appl. No.: 17/333,589

(22) Filed: May 28, 2021

Related U.S. Application Data
(60) Provisional application No. 63/031,609, filed on May 29, 2020.

(51) Int. Cl. D06N 7/00; B32B 27/12

(52) U.S. Cl. CPC D06N 7/0036; D06N 7/0076; D06N 2203/061; B32B 2471/02; B32B 27/12

(57) ABSTRACT

A carpet and a method of making a carpet are described. The carpet and the method of making the carpet does not involve the use of a latex precoat. This is useful for recycling purposes.

### CROSS-REFERENCE TO RELATED APPLICATIONS

This application claims the benefit of U.S. Provisional Application No. 63/031,609 filed May 29, 2020, which is incorporated herein by reference in its entirety.

### FIELD OF THE INVENTION

The present invention pertains to a carpet and a method of making a carpet without latex. In particular, the disclosed carpet and the method of making the carpet does not utilize a precoat comprising latex.

### BACKGROUND OF THE INVENTION

A typical carpet has a latex precoat layer that binds tufted fibers to a primary backing layer to prevent the tufted fibers from being pulled apart from the primary backing layer and the carpet. However, latex is not compatible with the recycling process of polyesters, which is the main component in many carpets. Thus, recycling of carpets having a latex precoat layer requires that the latex precoat is separated from the rest of the carpet prior to performing the polyester recycling process.

The disclosed carpet and the method of making the carpet solves this issue by providing a carpet and a method of making a carpet that does not utilize a precoat comprising latex.

### SUMMARY OF THE INVENTION

In accordance with the purpose(s) of the invention, as embodied and broadly described herein, the invention, in one aspect, relates to a carpet that does not comprise a latex precoat layer. The carpet comprises a greige good comprised of i) a primary backing component having a face surface and a back surface: ii) a plurality of fibers comprising a polyester tufted into the primary backing component such that the plurality of fibers extend from the face surface of the primary backing component and are exposed at the back surface of the primary backing component; and iii) a layer of a hot melt adhesive comprising a polyester on the back surface of the primary backing component. In the disclosed carpet, a portion of the plurality of fibers exposed at the back surface of the primary backing component are fused together. Also, in the disclosed carpet, the plurality of fibers are bonded to the primary backing by the layer of the hot melt adhesive. The carpet does not comprise a latex precoat layer.

Also disclosed herein is a method of making a carpet. The method comprises: a) providing a greige good comprised of i) a primary backing component having a face surface and a back surface: ii) a plurality of fibers comprising a polyester tufted into the primary backing component such that the plurality of fibers extend from the face surface of the primary backing component and are exposed at the back surface of the primary backing component; and iii) a layer of a hot melt adhesive comprising a polyester on the back surface of the primary backing component. The method further comprises applying a sufficient amount of heat to the greige good, thereby: i) fusing together a portion of the plurality of fibers exposed at the back surface of the primary backing component; and melting the hot melt adhesive comprising the polyester to bond the plurality of fibers to the primary backing component by the hot melt adhesive. The carpet made by the method does not comprise a latex precoat layer.

Also disclosed herein is a method of making a carpet. The method comprises: a) providing a primary backing component having a face surface and a back surface. The method comprises applying a layer of a hot melt adhesive comprising a polyester on the back surface of the primary backing component. After the step of applying the layer of the hot melt adhesive comprising the polyester to the primary backing, the method comprises tufting a plurality of fibers comprising a polyester through the primary backing such that the plurality of fibers extend from the face surface of the primary backing component and are exposed at the back surface of the primary backing component, thereby producing a greige good. The method then comprises applying a sufficient amount of heat to the greige good, thereby i) fusing together a portion of the plurality of fibers exposed at the back surface of the primary backing component; and ii) melting the hot melt adhesive comprising the polyester to bond the plurality of fibers to the primary backing component by the hot melt adhesive. The carpet made by the method does not comprise a latex precoat layer.

Additional aspects of the invention will be set forth, in part, in the detailed description, and claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

FIG. 1 shows a scheme of an exemplary non-limiting carpet disclosed herein.

FIGS. 2A-2D show a photographs of exemplary non-limiting carpets disclosed herein.

### DETAILED DESCRIPTION OF THE INVENTION

The present invention can be understood more readily by reference to the following detailed description, examples, drawings, and claims, and their previous and following description. However, before the present compositions, articles, devices, systems, and/or methods are disclosed and described, it is to be understood that this invention is not limited to the specific compositions, articles, devices, systems, and/or methods disclosed unless otherwise specified, as such can, of course, vary. It is also to be understood that the terminology used herein is for the purpose of describing particular aspects only and is not intended to be limiting.

The following description of the invention is also provided as an enabling teaching of the invention in its best, currently known aspect. To this end, those of ordinary skill in the relevant art will recognize and appreciate that changes and modifications can be made to the various aspects of the invention described herein, while still obtaining the beneficial results of the present invention. It will also be apparent that some of the desired benefits of the present invention can be obtained by selecting some of the features of the present invention without utilizing other features. Accordingly, those of ordinary skill in the relevant art will recognize that many modifications and adaptations to the present invention are possible and can even be desirable in certain circumstances and are thus also a part of the present invention. Thus, the following description is provided as illustrative of the principles of the present invention and not in limitation thereof.

Various combinations of elements of this disclosure are encompassed by this invention, e.g. combinations of elements from dependent claims that depend upon the same independent claim.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

All publications mentioned herein are incorporated herein by reference to disclose and describe the methods and/or materials in connection with which the publications are cited.

It is also to be understood that the terminology used herein is for the purpose of describing particular aspects only and is not intended to be limiting. As used in the specification and in the claims, the term “comprising” may include the aspects “consisting of” and “consisting essentially of.” Unless defined otherwise, all technical and scientific terms used herein have the same meaning as commonly understood by one of ordinary skill in the art to which this invention belongs. In this specification and in the claims which follow, reference will be made to a number of terms which shall be defined herein.

As used herein, the singular forms “a,” “an” and “the” include plural referents unless the context clearly dictates otherwise. Thus, for example, reference to a “polymer” includes aspects having two or more polymers unless the context clearly indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “optional” or “optionally” mean that the subsequently described event or circumstance may or may not occur, and that the description includes instances where said event or circumstance occurs and instances where it does not.

“Carpet composition” is used herein in the manner as would be recognized by one of ordinary skill in the art. The definition of carpet composition as used herein includes any known in the art carpet products. As an example, and without limitation, the term “carpet composition” includes carpet tiles, rugs, and turfs. As used herein, and unless the context clearly indicates otherwise, the term carpet composition is used to generically include broadloom carpets and area rugs. To that “broadloom carpet” means a broadloom textile flooring product manufactured for and intended to be used in roll form.

The definition of carpet composition herein does not include products that would be known to one of ordinary skill in the art as “resilient flooring.” As an example, products that fall under the category of resilient flooring include, but are not limited to, linoleum, vinyl tiles, cork tiles, rubber tiles and floor mats.

As used herein, the term “by weight,” when used in conjunction with a component, unless specially stated to the contrary is based on the total weight of the formulation or composition in which the component is included. For example, if a particular element or component in a composition or article is said to have 8% by weight, it is understood that this percentage is in relation to a total compositional percentage of 100%.

A weight percent of a component, or weight %, or wt. %, unless specifically stated to the contrary, is based on the total weight of the formulation or composition in which the component is included.

References in the specification and concluding claims to parts by weight of a particular element or component in a composition or article, denotes the weight relationship between the element or component and any other elements or components in the composition or article for which a part by weight is expressed. Thus, in a composition or a selected portion of a composition containing 2 parts by weight of component X and 5 parts by weight component Y, X and Y are present at a weight ratio of 2:5, and are present in such ratio regardless of whether additional components are contained in the composition.

In some instances, the parts per weight of a component is based on the weight of the composition “on a dry basis,” and thus, refers to “dry parts,” which indicates the parts per weight of the composition without water or any other liquid or fluid. For example, the composition of the precoat in a finished product can be expressed in the dry parts.

In other instances, the parts per weight of a component is based on the weight of the composition “on a wet basis,” and thus, refers to “wet parts,” which indicates the parts per weight of the composition in the presence of water or any other liquid or fluid as defined. For example, the composition of the precoat in a blended or compounded form can be expressed in the wet parts.

As used herein, the term “substantially,” in, for example, the context “substantially free” refers to a composition having less than about 1% by weight, e.g., less than about 0.5% by weight, less than about 0.1% by weight, less than about 0.05% by weight, or less than about 0.01% by weight of the stated material, based on the total weight of the composition.

It is further understood that the term “substantially,” when used in reference to a composition, refers to at least about 60% by weight, e.g., at least about 65%, at least about 70%, at least about 75%, at least about 80%, at least about 85%, at least about 90%, at least about 91%, at least about 92%, at least about 93%, at least about 94%, at least about 95%, at least about 96%, at least about 97%, at least about 98%, at least about 99%, or about 100% by weight, based on the total weight of the composition, of a specified feature or component.

As used herein, the term “substantially,” in, for example, the context “substantially identical reference composition,” refers to a reference composition comprising substantially identical components in the absence of an inventive component. In another exemplary aspect, the term “substantially,” in, for example, the context “substantially identical reference composition,” refers to a reference composition comprising substantially identical components and wherein an inventive component is substituted with a common in the art component.

As used herein, the term “substantially,” in, for example, the context “substantially similar wet and dry delamination strength,” refers to values of wet delamination strength that are different from values of dry delamination strength by about 30% or less, by about 20% or less, by about 10% or less, by about 5% or less, by about 1% or less, or by about 0.5% or less.

The term “fiber” as used herein includes fibers of extreme or indefinite length (i.e. filaments) and fibers of short length (i.e., staple fibers).

The term “yarn” as used herein refers to a continuous strand or bundle of fibers.

As used herein, the term “copolymer” refers to a polymer formed from two or more different repeating units (monomer residues). By way of example and without limitation, a copolymer can be an alternating copolymer, a random copolymer, a block copolymer, or a graft copolymer.

In some aspects of the present invention, woven textiles can be used. Woven textiles have the appearance of two-sets of parallel threads interlaced at generally right angles to each other in the plane of the fabric. “Warp” yarns lie along the length of the fabric and “weft” yarns lie in the transverse direction, i.e. across the width of the fabric. The type of yarns used to produce a woven textile can be monofilament, multifilament, a combination of each type, or slit film yarns. In some aspects of the invention, the term “tape-spun” yarn refers to yarn having a slit film yarn in the warp direction and spun (relatively short staple length) yarn in the weft direction. In other aspects of the invention, the term “tape-tape” yarn refers to yarn having a slit film yarn both in the warp and the weft directions.

As described herein, the term “semipermeable” refers to materials that do not allow certain substances to permeate but do allow certain other specified materials to pass through it. For example, and without limitation, a semipermeable fluid barrier can be permeable to gases and impermeable to liquids, or vice versa.

As described herein, the term “impermeable” refers to materials that do not allow the disclosed substances to pass through it. For example, and without limitation, a fluid impermeable material can be impermeable to both liquids and gases.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

### Carpet Structures

The present invention may be understood more readily by reference to the following detailed description of various aspects of the invention and the examples included therein and to the Figures and their previous and following description.

A typical commercial carpet or rug has a primary backing layer, which can be a woven sheet or a nonwoven, spunbonded sheet made mostly of polypropylene (PP) or polyester (PET), and yarn (i.e. plurality of fibers), which is tufted into the primary backing layer to make the carpet or rug surface commonly used as a flooring. The carpet or rug, in this state, can be easily be pulled apart as the tufted yarn is not yet bonded to the primary backing. Bonding the tufted yarn to the primary backing is typically done with a precoat latex layer.

Conventionally, a precoat latex layer includes a latex compound applied to the back side of the tufted carpet as well as other textiles to bond threads and filaments together and add stiffness and stability to the finished product. The precoat latex layer is often filled with inert mineral fillers such as calcium carbonate. Original latex compounds have been rubber based, which “cure” upon application and drying to bind components together. Precoat latex layers have evolved from rubber type compounds to more polymer-like compounds but still requires a “curing” reaction which alters the molecular structure of the compound. The finished and cured product is detrimental to recycling, because it is a cross-linked product and must be separated from the polymer (i.e. polyester) components of the carpet or rug.

As markets demand recyclable products, efforts are being made to replace the latex component with something more compatible with a polyester recycling process. The reason latex with calcium carbonate has been the mainstay component in commercial carpets has been its economic value, as it costs much less than any plastic or polymer component available today.

The carpet disclosed herein and the disclosed method of making the carpet solves the issues associated with the use of latex described above. A latex free hot melt adhesive in combination with fused fibers of polyester is used in the disclosed carpet. The combination of a latex free hot melt adhesive and a process that involves a contacting the back surface of the primary backing to a hot surface (such as the surface of a roller) provide for a product that meets nominal carpet specifications and uses much less hot melt adhesive than other processes currently in practice.

The plurality of fibers tufted into the primary backing are fused to one another while, at the same time, bonding the fused plurality of fibers to the primary backing with the hot melt adhesive. This is accomplished by exposing the back surface of the primary backing to a hot surface (such as the surface of a roller), which has a temperature that is close to the melting temperature of the plurality of fibers. The plurality of fibers is in contact with the surface long enough to soften to a point where they fuse together. A difficulty with this process can be the application of too much heat on the back side of the yarn bundle (exposed to the hot surface) before enough heat has penetrated the bundle to fuse filaments closest to the primary backing. If the exposed surface becomes too hot, the fused plurality of fibers become brittle and individual fibers can break away from the bundle which will degrade the wear properties of the overall carpet or rug. In contrast, if not enough heat penetrates the plurality of fibers, the inside of the plurality of fibers does not fuse and will allow individual filaments to come loose which will again degrade the wear properties of the carpet or rug.

As described herein, a light layer of hot melt adhesive is applied to the primary backing prior to the tufting process. This process places the hot melt adhesive between the back side of the tuft and the primary backing. This enhancement is used in conjunction with the heat fusing process described above to achieve complete fusing of the plurality of fibers in combination with the bonding the plurality of fibers to the primary backing by the hot melt adhesive. The heat from the hot surface penetrates the plurality of fibers and, as it is fusing the portion of the plurality of fibers closest to the heat, it also activates the hot melt adhesive. The temperature that is used is below the actual melting temperature of the plurality of fibers but above the melting temperature of the hot melt adhesive. As such, the hot melt adhesive flows into the plurality of fibers, thereby bonding them together and also bonding them to the primary backing.

In some aspects, the disclosure relates to a carpet comprising: (a) a greige good comprising: i) a primary backing component having a face surface and a back surface; a plurality of fibers comprising a polyester tufted into the primary backing component such that the plurality of fibers extend from the face surface of the primary backing component and are exposed at the back surface of the primary backing component; and iii) a layer of a hot melt adhesive comprising a polyester on the back surface of the primary backing component, wherein a portion of the plurality of fibers exposed at the back surface of the primary backing component are fused together, wherein the plurality of fibers are bonded to the primary backing by the layer of the hot melt adhesive, wherein the carpet does not comprise a latex precoat layer.

In one aspect, the carpet does not comprise latex.

In one aspect, the carpet consists of polyester. In one aspect, the carpet consists essentially of polyester.

Also disclosed herein carpet can have a length sufficient to be wound on a broadloom roller. In addition, the carpet is capable of lying flat against an underlying subfloor structure in the absence of an attachment mechanism.

In certain aspects, the present invention pertains to any carpet constructed with a primary backing component and includes tufted carpet. To form the tufted carpet, yarn (i.e. plurality of fibers) is tufted through the primary backing component such that the longer length of each stitch extends through the face surface of the primary backing component, and the shorter length of each stitch are exposed at the back surface of the primary backing component.

In one aspect, the carpet disclosed herein can be recycled. In one aspect, the carpet disclosed herein can be recycled in a polyester recycling process. For example, the carpet disclosed herein can be recycled in a polyester recycling process without the need for separating components from the carpet prior to recycling.

In another aspect, the carpet disclosed herein can comprise at least 80% by weight of polyester. For example, the carpet disclosed herein can comprise at least 85% by weight of polyester. In another example, the carpet disclosed herein can comprise at least 90% by weight of polyester. In yet another example, the carpet disclosed herein can comprise at least 95% by weight of polyester. In yet another example, the carpet disclosed herein can comprise at least 98% by weight of polyester.

In some aspects, the carpet disclosed herein exhibits strength measured by Tuft Bind test from about 5 pounds to about 25 pounds, including exemplary values of about 6 pounds, about 7 pounds, about 8 pounds, about 9 pounds, about 10 pounds, about 11 pounds, about 12 pounds, about 13 pounds, about 14 pounds, about 15 pounds, about 16 pounds, about 17 pounds, about 18 pounds, about 19 pounds, about 20 pounds, about 21 pounds, about 22 pounds, about 23 pounds, and about 24 pounds. In yet other aspects, the carpet composition can exhibit strength measured by Tuft Bind test in any range between any two of the foregoing endpoints.

A. Fibers

In some aspects, the plurality of fibers are present as a yarn. In other aspects, the plurality of fibers are present as separate fibers. In some aspects, the plurality of fibers form tufts. In some aspects, a portion of the plurality of the fibers are exposed at the back surface of the primary backing component. In some aspects, a portion of the plurality of the fibers are exposed at the back surface of the primary backing component and are exposed beyond the hot melt adhesive layer. In yet other aspects, a portion of the plurality of the fibers are exposed at the back surface of the primary backing component in a form of back stitches.

In one aspect, the plurality of fibers that are exposed at the back surface of the primary backing component are also tufted through the layer of a hot melt adhesive. That is, the hot melt adhesive is applied to the primary backing prior to tufting the plurality of fibers into the primary backing and through the hot melt adhesive layer. Accordingly, the hot melt adhesive is not a barrier between the plurality of fibers that are exposed at the back surface of the primary backing component and the hot surface used to supply the sufficient amount of heat, as described herein, to the plurality of fibers that are exposed at the back surface of the primary backing component.

The plurality of fibers comprise a polyester. The term “polyester fiber” as utilized herein, refers to the manufactured fiber in which the fiber forming substance is any long-chain synthetic polymer composed of at least 85% by weight of an ester of a substituted aromatic carboxylic acid, including but not restricted to substituted terephthalic units, p(—R—O—CO—C₆H₄—CO—O—)ₓ and parasubstituted hydroxy-benzoate units, p(—R—O—CO—C₆H₄—O—)ₓ. In some aspects, the plurality of the polyester fibers comprise polyethylene terephthalate (PET) homopolymers and copolymers, polybutylene terephthalate (PBT) homopolymers and copolymers, and the like, including those that contain comonomers such as cyclohexanedimethanol, cyclohexanedicarboxylic acid, and the like.

In yet further aspects, the plurality of fibers can further comprise natural fibers, acrylics, viscose, rayon, cellulose acetate, linen, silk, cotton, wool, or any combination thereof.

As understood by one of ordinary skill in the art, the plurality of fibers can comprise any types or forms of fibers. For example, and without limitation, the plurality of fibers can comprise staple fibers or bulked continuous filament fibers.

Fibers comprising polyester can have any suitable shape. For example, the fibers comprising polyester be round, delta or trilobal in shape. The Mod Ratio of the fibers comprising polyester can vary from a minimum of 1.00 to a maximum of 4.00. The number of fibers comprising polyester per bundle of fiber can range from a low of 50 to a high of 360. Bundles of fibers comprising polyester are twisted together in either an S twist or a Z twist configuration in a range from 3 to 6 twists per inch. The twisted bundles of fibers comprising polyester are heat set using either a Superba (continuous steam and pressure) or a Suessen (dry heat) technology. Such a product is known as yarn, which is also referred to as a plurality of fibers, as used herein. The plurality of fibers can be tufted into a primary backing using common tufting technology, the lengths of the tufted yarn can vary as well as the number of tufts per inch. The tufted plurality of fibers can be either a closed loop or a cut pile. The primary backing can be woven or a non-woven polyester, as disclosed herein. A CoPET film, referred to herein as a hot melt adhesive layer, used for adhesion can be applied as a film to the primary backing at a rate from a minimum of 1 oz/sq.yd. to 8 oz/sq.yd, as disclosed herein. The melting point of this CoPET adhesive film can range from 110 to 200° C.

In still further aspects, the fibers can form a face pile of any thickness depending on a specific application. In certain aspects, the face pile has a thickness of about 5 inch or less, about 4.5 inch or less, about 4 inch or less, about 3.5 inch or less, about 3 inch or less, about 2.4 inch or less, about 2 inch or less, or about 1.5 inch or less, or about 1 inch or less, or about 0.5 inch or less. In yet other aspects, the face pile has a thickness of about 0.5 inch, about 1 inch, about 1.5 inch, about 2 inch, about 2.5 inch, about 3 inch, about 3.5 inch, about 4 inch, about 4.5 inch, or about 5 inch.

In one aspect, the fibers in the carpet can have an overall weight from 12 to 125 oz per square yard. For example, the fibers in the carpet can have an overall weight from 12 to 100 oz per square yard. In another example, the fibers in the carpet can have an overall weight from 12 to 75 oz per square yard. In yet another example, the fibers in the carpet can have an overall weight from 25 to 50 oz per square yard. In yet another example, the fibers in the carpet can have an overall weight from 50 to 125 oz per square yard. In yet another example, the fibers in the carpet can have an overall weight from 75 to 125 oz per square yard. In yet another example, the fibers in the carpet can have an overall weight from 100 to 125 oz per square yard. In yet another example, the fibers in the carpet can have an overall weight from 50 to 100 oz per square yard.

B. Primary Backings

In certain aspects, the primary backing component comprises a polyester. The primary backing component can be woven and non-woven. In certain aspects, the primary backing component can comprise non-woven webs, or spunbonded materials. In some aspects, the primary backing component can comprise a combination of woven and non-woven materials. In some other aspects, the primary backing component can comprise a woven polyethylene terephthalate (PET). In yet other aspects, the primary backing component can comprise a woven PET having a post-consumer and/or post-industrial content.

In certain aspects, the primary backing component is a spun-bond primary backing component. The spun bond backing can be produced by depositing extruded, spun filaments onto a collecting belt in a uniform random manner followed by bonding the fibers. The fibers are separated during the web laying process by air jets or electrostatic charges. The collecting surface is usually perforated to prevent the air stream from deflecting and carrying the fibers in an uncontrolled manner. Bonding imparts strength and integrity to the web by applying heated rolls or hot needles to partially melt the polymer and fuse the fibers together. Since molecular orientation increases the melting point, fibers that are not highly drawn can be used as thermal binding fibers. In some aspect, the spun-bond primary backing component can comprise a bi-component filament of a sheath-core type. In some aspects, the polymeric core component can have a higher melting point than the polymeric sheath component. In some aspects, the polymeric core component can comprise polyester. In yet other aspects, the polyester can comprise polyethylene terephthalate, polybutylene terephthalate, or polyparaphenylene terephthalamide. In yet other aspects, the polymeric core comprises polyethylene terephthalate. In further aspects, the sheath polymer can comprise a polyester. The exemplary sheath-core primary backing component can be commercially available from Bonar. In yet other aspects, a polyester non-woven primary backing can be commercially available from Freudenberg.

C. Hot Melt Adhesive

In some aspect, the carpet composition can comprise a hot melt adhesive which functions as a precoat composition. In certain aspects, the hot melt adhesive comprises a thermoplastic polymer.

The hot melt adhesive layer does not comprise latex.

In one aspect, the hot melt adhesive comprises a ethylene-vinyl acetate, a polyethylene, a polypropylene, a polybutene, an amorphous polyolefin, a polyamide, a polyester, a co-polyester, a polyurethane, or a polyethylene terephthalate, or a combination thereof. For example, the hot melt adhesive can comprise a polyester. Hot melt adhesives comprising a polyester are commercially available, for example, under the trade name Griltex®, sold by EMS-Griltech, or by other commercial sources, including Reynolds Company Adhesive and Coatings, 3M, and Henkel.

In one aspect, the layer of the hot melt adhesive can be present in an amount from about 1 to about 8 ounces/sq. yard (OSY), including exemplary amounts of 1.0, 1.5, 2.0, 2.5, 3.0, 3.5, 4.0, 4.5, 5.0, 5.5, 6.0, 6.5, 7.0, 7.5, and 8.0 OSY, and any range of coating weights derived from these values. For example, the hot melt adhesive can be present in an amount from about 2.0 to about 6.0 OSY, or from about 2.0 to about 4.0 OSY, or from about 1.0 to about 3.0 OSY.

In one aspect, the hot melt adhesive layer is an extruded hot melt adhesive layer.

In one aspect, the hot melt adhesive layer is an extruded hot melt adhesive layer. In some aspects, a hot melt adhesive can be extruded through a die so as to make a sheet which is as wide as the carpet composition.

Exemplary extrusion coating configurations can include, without limitation, a monolayer T-type die, single-lip die coextrusion coating, dual-lip die coextrusion coating, a coat hanger die, and multiple stage extrusion coating. Preferably, the extrusion coating equipment is configured to apply a total coating weight of from about 1.0 to about 8.0 ounces/yd² (OSY), including exemplary amounts of 1.0, 1.5, 2.0, 2.5, 3.0, 3.5, 4.0, 4.5, 5.0, 5.5, 6.0, 6.5, 7.0, 7.5, and 8.0 ounces/yd² (OSY), and any range of coating weights derived from these values.

In one aspect, the hot melt adhesive, such as the hot melt adhesive comprising the polyester, can have a lower melting temperature than the plurality of fibers comprising the polyester. This allows for a sufficient amount of heat to be applied to the greige good, such that at least a portion of the plurality of fibers comprising the polyester softens, which causes the soft portions of the plurality of fibers to fuse together. At the same time, the sufficient amount of heat causes the hot melt adhesive to melt, which upon cooling and hardening causes the plurality of fibers to be bonded to the primary backing by the layer of the hot melt adhesive. The melted hot melt adhesive also flows between individual fibers in the plurality of fibers to also bind the plurality of fibers together. Thus, a portion of the plurality of the fibers exposed at the back surface of the primary backing component are fused together, and the plurality of fibers are bonded to the primary backing by the layer of the hot melt adhesive.

The hot melt adhesive can have a melting temperature from about 110 to about 200° C. The fibers disclosed herein can have a melting temperature above about 200° C. The fibers disclosed herein can have a softening temperature above about 200° C. For example, the fibers disclosed herein can have a softening temperature from about 200° C. to about 300° C. Thus, the sufficient amount of heat to be applied to the greige good can be above about 200° C., such as, for example, from about 200° C. to about 300° C., or from about 230° C. to about 280° C. The heat can be applied by contacting the greige good with a roller having a temperature from above about 200° C., such as, for example, from about 200° C. to about 300° C., or from about 230° C. to about 280° C. for a period of time. The period of time can be from 3 seconds to 10 minutes, such as from 5 seconds to 1 minute, or from 5 seconds to 25 seconds.

In one aspect, the hot melt adhesive can have a melting temperature that is from 10° C. to about 50° C. lower than the melting temperature of the plurality of fibers. For example, the hot melt adhesive can have a melting temperature that is from 10° C. to about 40° C. lower than the melting temperature of the plurality of fibers. In another example, the hot melt adhesive can have a melting temperature that is from 10° C. to about 30° C. lower than the melting temperature of the plurality of fibers. In another example, the hot melt adhesive can have a melting temperature that is from 10° C. to about 20° C. lower than the melting temperature of the plurality of fibers. In another example, the hot melt adhesive can have a melting temperature that is from 20° C. to about 50° C. lower than the melting temperature of the plurality of fibers. In another example, the hot melt adhesive can have a melting temperature that is from 30° C. to about 50° C. lower than the melting temperature of the plurality of fibers. In another example, the hot melt adhesive can have a melting temperature that is from 40° C. to about 50° C. lower than the melting temperature of the plurality of fibers.

In one aspect, the hot melt adhesive can have a softening temperature that is from 10° C. to about 50° C. lower than the softening temperature of the plurality of fibers. For example, the hot melt adhesive can have a softening temperature that is from 10° C. to about 40° C. lower than the softening temperature of the plurality of fibers. In another example, the hot melt adhesive can have a softening temperature that is from 10° C. to about 30° C. lower than the softening temperature of the plurality of fibers. In another example, the hot melt adhesive can have a softening temperature that is from 10° C. to about 20° C. lower than the softening temperature of the plurality of fibers. In another example, the hot melt adhesive can have a softening temperature that is from 20° C. to about 50° C. lower than the softening temperature of the plurality of fibers. In another example, the hot melt adhesive can have a softening temperature that is from 30° C. to about 50° C. lower than the softening temperature of the plurality of fibers. In another example, the hot melt adhesive can have a softening temperature that is from 40° C. to about 50° C. lower than the softening temperature of the plurality of fibers.

D. Secondary Backing System

### Secondary Backing Layer

In certain aspects, the secondary backing layer is adhered to the back surface of the previously described carpet structure. This means that the secondary backing layer is adhered to the back surface of the primary backing by the fused plurality of fibers and/or the hot melt adhesive.

In one aspect, the secondary backing layer can be adhered to the back surface of the primary backing by laminating the secondary backing layer to the back surface of the primary backing. For example, an additional layer of adhesive can be applied to bond the secondary backing to the previously described carpet structure.

In some aspects of the invention, the carpet composition comprises a secondary backing, wherein the secondary backing is adhered to the back surface of the previously described carpet structure component by the adhesive compositions. In one aspect the secondary backing comprises a woven material. In another aspect, the secondary backing comprises a tape-tape yarn, or a tape-spun yarn. In certain aspects, the secondary backing is a tape-tape yarn woven material.

In further aspects, the secondary backing material is a material known as fiber lock weave or “FLW.” FLW is a fabric which includes fibers needle punched into it. Sometimes FLW is used as a primary backing component on a carpet with a low pile weight.

In some aspects, the secondary backing can be a woven needle punched polypropylene fabric such as SoftBac® manufactured by Shaw Industries, Inc. In this exemplary aspect, this material has been enhanced by having about 1.5 ounce/sq. yard of polypropylene fibers or polyethylene terephthalate fibers needle punched onto one side of it and has a total basis weight of about 3.5 ounce/sq. yard. This needle punched fabric can be laminated so as to have the polypropylene fibers embedded within the adhesive backing layer. In still further aspects other materials can be used for the secondary backing, for example, and without limitation, if an integral pad is desired, a polyurethane foam or other cushion material can be laminated to the back side of the carpet. Such backings can be used for broadloom carpet.

In yet other aspects, the secondary backing comprising a non-woven material. In certain aspects, the secondary backing can comprise a spunbond non-woven material. The spunbond backing can be produced by depositing extruded, spun filaments onto a collecting belt in a uniform random manner followed by bonding the fibers. The fibers are separated during the web laying process by air jets or electrostatic charges. The collecting surface is usually perforated to prevent the air stream from deflecting and carrying the fibers in an uncontrolled manner. Bonding imparts strength and integrity to the web by applying heated rolls or hot needles to partially melt the polymer and fuse the fibers together. Since molecular orientation increases the melting point, fibers that are not highly drawn can be used as thermal binding fibers. In some aspect, the spun-bond secondary backing component can comprise a bi-component filament of a sheath-core type. In some aspects, the polymeric core component can have a higher melting point than the polymeric sheath component. In some aspects, the polymeric core component can comprise polyester. In yet other aspects, the polyester can comprise polyethylene terephthalate, polybutylene terephthalate, or polyparaphenylene terephthalamide. In yet other aspects, the polymeric core comprises polyethylene terephthalate. In further aspects, the sheath polymer can comprise a polyester. The exemplary sheath-core secondary backing component can be commercially available from Bonar. In yet other aspects, a polyester non-woven secondary backing can be commercially available from Freudenberg.

In some aspects, it is contemplated that the secondary backing material to be extruded or applied by any other technique known in the art. In some aspects, the secondary backing material of this invention may optionally include exemplary additives such as foaming agents, pH controllers, flame retardants, fillers, tackifiers, wetting agents, dispersing agents, anti-microbial agents, lubricants, dyes, anti-oxidants, and the like, which are well known to those skilled in the art, without loss of the characteristic properties.

In one aspect, the secondary backing material can further comprise one or more flame retardants sufficient to ensure the carpet structure satisfies the requirements of the radiant flux floor covering test according to the ASTM-E648 testing procedures. In particular, according to certain aspects, the carpet compositions of the present invention exhibit a Class 1 critical radiant flux of greater than 0.45 watts per cm² as measured according to ASTM-E648. According to other aspects of the invention, the carpet compositions described herein can exhibit a Class 2 critical radiant flux in the range of from 0.22 to 0.44 watts per cm² as measured according to ASTM-E648. In still further aspects, the carpet compositions of the present invention can exhibit an unclassifiable critical radiant flux of less than 0.22 watts per cm² as measured according to ASTM-E648.

Exemplary flame retardants that can be incorporated into the secondary backing materials of the present invention include, without limitation, organo-phosphorous flame retardants, red phosphorous magnesium hydroxide, magnesium dihydroxide, hexabromocyclododecane, bromine containing flame retardants, brominated aromatic flame retardants, melamine cyanurate, melamine polyphosphate, melamine borate, methylol and its derivatives, silicon dioxide, calcium carbonate, resourcinol bis-(diphenyl phosphate), brominated latex base, antimony trioxide, strontium borate, strontium phosphate, monomeric N-alkoxy hindered amine (NOR HAS), triazine and its derivatives, high aspect ratio talc, phosphated esters, organically modified nanoclays and nanotubes, non-organically modified nanoclays and nanotubes, ammonium polyphosphate, polyphosphoric acid, ammonium salt, friaryl phosphates, isopropylated triphenyl phosphate, phosphate esters, magnesium hydroxide, zinc borate, bentonite (alkaline activated nanoclay and nanotubes), organoclays, aluminum trihydrate (ATH), azodicarbonamide, diazenedicarboxamide, azodicarbonic acid diamide (ADC), friaryl phosphates, isopropylated triphenyl phosphate, triazine derivatives, alkaline activated organoclay and aluminum oxide. Any desired amount of flame retardant can be used in the secondary backing material of the instant invention and the selection of such amount will depend, in part, upon the particular flame retardant used and desired carpet applications. Such amounts can be readily determined through no more than routine experimentation.

Exemplary and non-limiting fillers that can be incorporated into the secondary backing materials of the present invention can include calcium carbonate, fly-ash, recycled calcium carbonate, aluminum trihydrate, talc, nano-clay, barium sulfate, barite, barite glass fiber, glass powder, glass cullet, metal powder, alumina, hydrated alumina, clay, magnesium carbonate, calcium sulfate, silica, glass, fumed silica, carbon black, graphite, cement dust, feldspar, nepheline, magnesium oxide, zinc oxide, aluminum silicate, calcium silicate, titanium dioxide, titanates, glass microspheres, chalk, calcium oxide, and any combination thereof. In one aspect, the secondary backing material comprises inorganic filler with high heat content. In some aspects, it is for the filler to exhibit relatively high heat content. Examples of such fillers include, but are not limited to, calcium carbonate, aluminum trihydrate, talc, and barite. The exemplified high heat content fillers allow the extrudate to remain at elevated temperatures longer with the beneficial result of providing enhanced encapsulation and penetration. In this aspect, the high heat content fillers should be ground or precipitated to a size that can be conveniently incorporated in an extrusion coating melt stream. Exemplary non-limiting particle sizes for the inorganic filler material can include particle sizes in the range of from about 1 to about 50 microns. Still further, it should also be understood that the filler component can be present in any desired amount. However, in an exemplary aspect, the filler is present in an amount in the range of from about 10 weight % to about 90 weight %, based upon the total weight of the secondary backing material, including exemplary amounts of about 15 weight %, 20 weight %, 25 weight %, 30 weight %, 35 weight %, 40 weight %, 45 weight %, 50 weight %, 55 weight %, 60 weight %, 65 weight %, 70 weight %, 75 weight %, 80 weight %, and about 85 weight %. Still further, the amount of filler present can be in any range derived from any two of the above stated weight percentages.

In still another aspect, the secondary backing material can further comprise one or more tackifying additives. The tackifier can for example be tall oil or rosin based or, alternatively, can be an aliphatic or aliphatic aromatic hydrocarbon blend resin. As the tackifier is an optional component, the amount of tackifier can be, when present, in the range of from greater than 0 weight percent up to and even exceeding about 50 weight % of the secondary backing material. For example, in one aspect, the amount of tackifier can be in the range of from about 5 weight % to about 45 weight %. In still another aspect, the amount of tackifier can be in the range of from about 10 weight % to about 20 weight %.

### Polymer Film

As disclosed herein, the carpet composition disclosed herein can further comprise a polymer film that is disposed to the secondary backing. For example, the carpet composition disclosed herein can further comprise a polymer film that is laminated to the secondary backing.

In some aspects, the polymer film comprises a thermoplastic material. In yet other aspects, the polymer film is a thermoplastic film. In other aspects, the polymer film comprises polyester. In yet further aspects, the polymer film is a combination of polyethylene and polyester.

In certain aspects, the polymer film is an extruded film. In yet other aspects, the polymer film is a blown film. In a yet further aspect, the polymer film is a cast film. In a still further aspect, the polymer film is an engineered film. The term “engineered film” as used herein refers to a polymer film comprising same or different polymers and copolymers, wherein the film is formed by various techniques to ensure desirable properties. In some aspects, the engineered film is a reinforced film. In some aspects, and without limitation, the engineered reinforced film can comprise a plurality of layers of the same or different polymer or copolymer. In other aspects, the engineered film can comprise layers of polyethylene film sandwiched with a layer of polyester.

In some aspects, the polymer film disclosed herein can be a fluid barrier. In yet other aspects, the polymer film disclosed herein is not a fluid barrier. In yet other aspects, the polymer film is fluid impermeable. In yet other aspects, the polymer film is semipermeable material. In yet other aspects, the polymer film is semipermeable to fluids. In certain aspects, the polymer film is semipermeable to gases. In some aspects, the polymer film is semipermeable to all atmospheric gases. In exemplary aspects and without limitation, the polymer film is semipermeable to oxygen, hydrogen, carbon dioxide, carbon oxide, nitrogen, and the like. In yet other aspects, the polymer film is impermeable to gases. In certain aspects, the polymer film is impermeable, for example, and without limitations, to volatile organic compounds (VOCs), methane, carbon dioxide, carbon oxide, radon, gasoline, benzene and the like. In yet further aspects, the polymer film is impermeable to the vapors.

In certain aspect, the polymer film is impermeable to fluids. In one aspect, the polymer film is impermeable to aqueous fluids. In another aspect, the polymer film is impermeable to non-aqueous fluids. In a further aspect, the non-aqueous fluid is an organic fluid. In further exemplary aspects, the polymer film is impermeable to water, carbonate and non-carbonate beverages, juices, milk, wine, or any other alcohol substances, human or pet bodily fluids, food fluids, food processing fluids, rain, or snow. In yet other aspects, the polymer film is semipermeable to fluids. In still further aspects, the polymer film is semipermeable to aqueous fluids. In still further aspects, the polymer film is semipermeable to non-aqueous fluids. In still other aspects, the aqueous and non-aqueous fluids can be any fluids described herein.

As disclosed herein, in some aspects, the polymer film can have a thickness of less than about 10 mils. In other aspects, the polymer film can have a thickness of exemplary values of about 9.5 mils, 9.0 mils, 8.5 mils, 8.0 mils, 7.5 mils, 7.0 mils, 6.5 mils, 6.0 mils, 5.5 mils, about 5 mils, about 4.5 mils, about 4 mils, about 3.5 mils, about 3 mils, about 2.5 mils, about 2 mils, about 1.5 mils, about 1 mil, and about 0.5 mils. In other aspects, the polymer film can have a thickness in any range derived from any two of the above stated values. For example, and without limitation the polymer film can have thickness from about 1 mil to about 5.5 mils, or from about 2 mils to about 4 mils, or from about 1 mil to about 3.5 mils.

In some aspects, the polymer film is continuous. In other aspects, the polymer film is substantially free of perforations or pinholes. In yet other aspects, the polymer film is continuous and substantially free of perforations.

In still further aspects, the secondary backing system as disclosed herein provides stability and flexibility to the free-lay carpet composition. In yet other aspects, the secondary backing system has a thickness of less than about 100 mil, less than about 90 mil, less than about 80 mil, less than about 70 mil, less than about 60 mil, or less than about 50 mil. In yet other aspects, the secondary backing system has a thickness of greater than about 50 mil, greater than about 60 mil, greater than about 70 mil, greater than about 80 mil, greater than about 90 mil, or about 100 mil.

In yet other aspects, the secondary backing system has a thickness of less than about 500 mil, less than about 450 mil, less than about 400 mil, less than about 350 mil, less than about 300 mil, less than about 250 mil, less than about 200 mil, less than about 150 mil, less than about 100 mil, or less than about 50 mil. In yet other aspects, the secondary backing system has a thickness of greater than about 50 mil, greater than about 100 mil, greater than about 150 mil, greater than about 200 mil, greater than about 250 mil, greater than about 300 mil, greater than about 350 mil, greater than about 400 mil, greater than about 450 mil, or about 500 mil.

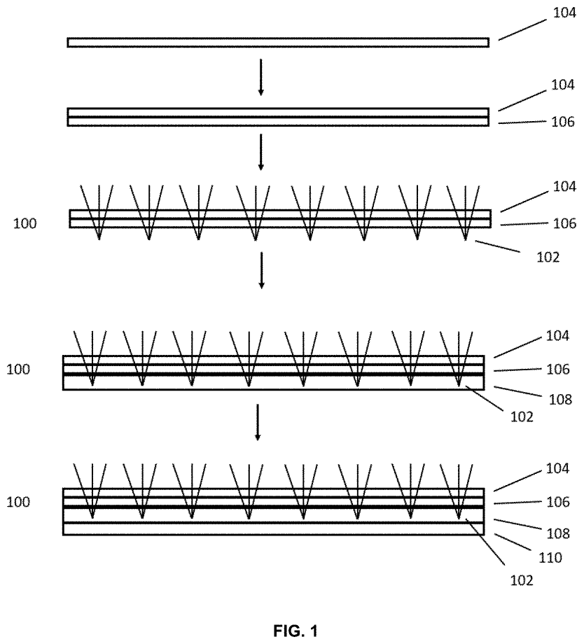

FIG. 1 schematically shows an exemplary aspect of this invention. Specifically, FIG. 1 demonstrates an exemplary carpet structure 100 (or greige good) disclosed herein. It is understood that this exemplary carpet structure can have any dimensions. It can be a tile, a roll, a strip, or any other structure disclosed herein. In yet other aspects, the exemplary carpet structure can have dimensions of 24″×24″ tiles, or 9″×36″ tiles, or 3′×12′ strips, etc. A plurality of fibers 102 are attached to or tufted into a primary backing component 104 and extends from a face surface of the primary backing component 104 and are exposed at the back surface of the primary backing component 104. A hot melt adhesive layer 106 is applied to the back surface of the primary backing component 104 prior to tufting the plurality of fibers 102 into the primary backing component 104. After the tufting process, the sufficient amount of heat is applied to the to the carpet structure 100 (or greige good), thereby: fusing together a portion of the plurality of fibers 102 exposed at the back surface of the primary backing component 104; and melting the hot melt adhesive 106 comprising the polyester to bond the plurality of fibers 102 to the primary backing component 104 by the hot melt adhesive 106. A secondary backing 108 can adhered to the primary backing 104. FIG. 1 is for illustrative purposes only and the plurality of fibers do not penetrate the secondary backing 108. An optional scrim can be present. A polymer film 110 can also be laminated to the secondary backing 108.

It is understood that in some aspects, an optional layer of the reinforcing material (not shown) can be embedded between a precoated greige goods and secondary backing material. The layer of reinforcing material has been found to enhance the dimensional stability of the carpet composition. Suitable reinforcing materials include dimensionally and thermally stable fabrics such as non-woven or wet-laid fiberglass scrims, as well as woven and non-woven thermoplastic fabrics (e.g. polypropylene, nylon and polyester). In some aspects, the reinforcement layer is a fiberglass scrim, for example, Duraglass that is commercially available from Johns Manville (about 2.0 oz/sq. yard). Alternatively, in other aspects, a reinforcement layer is a fiberglass scrim sold by Owens Corning (about 2.0 oz/sq. yard).

In certain aspects, the carpet composition disclosed herein comprises a carpet tile, a broadloom carpet, an area rug, or a synthetic turf. In yet other aspects, the carpet composition disclosed herein is a carpet tile, a broadloom carpet, an area rug, or a synthetic turf.

### Methods of Making Carpets

In still further aspects, disclosed herein are the methods of making carpet compositions, such as the carpet disclosed herein.

Disclosed herein is a method of making a carpet comprising: (a) providing a greige good comprising: i) a primary backing component having a face surface and a back surface; ii) a plurality of fibers comprising a polyester tufted into the primary backing component such that the plurality of fibers extend from the face surface of the primary backing component and are exposed at the back surface of the primary backing component; and iii) a layer of a hot melt adhesive comprising a polyester on the back surface of the primary backing component, (b) applying a sufficient amount of heat to the greige good, thereby: i) fusing together a portion of the plurality of fibers exposed at the back surface of the primary backing component; and ii) melting the hot melt adhesive comprising the polyester to bond the plurality of fibers to the primary backing component by the hot melt adhesive, wherein the carpet does not comprise a latex precoat layer.

Also disclosed herein is a method of making a carpet comprising: a) providing primary backing component having a face surface and a back surface; b) applying a layer of a hot melt adhesive comprising a polyester on the back surface of the primary backing component; c) after the step of applying the layer of the hot melt adhesive comprising the polyester to the primary backing, tufting a plurality of fibers comprising a polyester through the primary backing such that the plurality of fibers extend from the face surface of the primary backing component and are exposed at the back surface of the primary backing component, thereby producing a greige good; and d) applying a sufficient amount of heat to the greige good, thereby i) fusing together a portion of the plurality of fibers exposed at the back surface of the primary backing component; and ii) melting the hot melt adhesive comprising the polyester to bond the plurality of fibers to the primary backing component by the hot melt adhesive, wherein the carpet does not comprise a latex precoat layer. In one aspect step b) can comprise directly melting the hot melt adhesive on the back surface of the primary backing component or applying a film of the hot melt adhesive on the back surface of the primary backing component.

In one aspect, applying a sufficient amount of heat to the greige good comprises applying heat using a drum. A drum is also known as a roller, that has a hot surface that is in direct contact with the plurality of fibers that are exposed at the back surface of the primary backing component, which are also tufted through the layer of a hot melt adhesive. That is, the hot melt adhesive is applied to the primary backing prior to tufting the plurality of fibers into the primary backing and through the hot melt adhesive layer. Accordingly, the hot melt adhesive is not a barrier between the plurality of fibers that are exposed at the back surface of the primary backing component and the hot surface used to supply the sufficient amount of heat, as described herein, can be directly in contact with the plurality of fibers that are exposed at the back surface of the primary backing component. As such, the heat can be applied by contacting the greige good with a roller having a temperature from above about 200° C., such as, for example, from about 200° C. to about 300° C., or from about 230° C. to about 280° C. for a period of time. The period of time can be from 3 seconds to 10 minutes, such as from 5 seconds to 1 minute, or from 5 seconds to 25 seconds.

In one aspect, applying the sufficient amount of heat to the greige good causes the portion of the plurality of fibers exposed at the back surface of the primary backing component to soften but not melt.

The face of a tufted carpet can generally be made in three ways. First, for loop pile carpet, the yarn loops formed in the tufting process are left intact. Second, for cut pile carpet, the yarn loops are cut, either during tufting or after, to produce a pile of single yarn ends instead of loops. Third, some carpet styles include both loop and cut pile. One variety of this hybrid is referred to as tip-sheared carpet where loops of differing lengths are tufted followed by shearing the carpet at a height so as to produce a mix of uncut, partially cut, and completely cut loops. Alternatively, the tufting machine can be configured so as to cut only some of the loops, thereby leaving a pattern of cut and uncut loops. Whether loop, cut, or a hybrid, the yarn on the back surface of the primary backing component comprises tight, unextended loops. The combination of tufted yarn and a primary backing component without the application of an adhesive backing material or secondary backing material is referred to in the carpet industry as raw tufted carpet or greige goods. Here a greige good includes a layer of a hot melt adhesive that is applied prior to the tufting process. Greige goods become finished tufted carpet with the application of secondary backing materials or any other additional backings if present to the back surface of the primary backing material. In the aspects of the current invention, the greige goods become finished tufted carpet with the application of the secondary backing material.

In another aspect, any conventional tufting or needle-punching apparatus and/or stitch patterns can be used to make the carpet compositions of the present invention. Likewise, it does not matter whether tufted yarn loops are left uncut to produce a loop pile; cut to make cut pile; or cut, partially cut and uncut to make a face texture known as tip sheared. After the yarn is tufted or needle-punched into the primary backing component, the greige good can be conventionally rolled up with the back surface of the primary backing component facing outward and held until it is transferred to the backing line.

In one aspect, the layer of the hot melt adhesive can be present in an amount from about 1 to about 8 ounces/sq. yard (OSY), including exemplary amounts of 1.0, 1.5, 2.0, 2.5, 3.0, 3.5, 4.0, 4.5, 5.0, 5.5, 6.0, 6.5, 7.0, 7.5, and 8.0 OSY, and any range of coating weights derived from these values. For example, the hot melt adhesive can be present in an amount from about 2.0 to about 6.0 OSY, or from about 2.0 to about 4.0 OSY, or from about 1.0 to about 3.0 OSY.

The step of applying a layer of a hot melt adhesive comprising a polyester on the back surface of the primary backing component can be done in various ways. For example, the layer of the hot melt adhesive can be applied directly, such as with a roll over roller applicator, or a doctor blade. Alternatively, the layer of the hot melt adhesive can be applied indirectly, such as with a pan applicator. In one aspect, the layer of the hot melt adhesive can be applied by an extrusion process. In some aspects, a hot melt adhesive can be extruded through a die so as to make a sheet which is as wide as the carpet composition.

After applying a sufficient amount of heat to the greige good, thereby i) fusing together a portion of the plurality of fibers exposed at the back surface of the primary backing component; and ii) melting the hot melt adhesive comprising the polyester to bond the plurality of fibers to the primary backing component by the hot melt adhesive, a secondary backing material can be applied thereto. The additional backings can be applied by various methods. In some aspects, the secondary backing disclosed herein can be rolled on. In other aspects, the method can comprise the use of an extruded sheet of a thermoplastic material. In some aspects, a molten thermoplastic material can be extruded through a die so as to make a sheet which is as wide as the carpet composition.

Exemplary extrusion coating configurations can include, without limitation, a monolayer T-type die, single-lip die coextrusion coating, dual-lip die coextrusion coating, a coat hanger die, and multiple stage extrusion coating. Preferably, the extrusion coating equipment is configured to apply a total coating weight of from about 4 to about 60 ounces/yd² (OSY), including exemplary amounts of 5, 10, 15, 20, 25, 30, 35, 40, 45, 50 and 55 ounces/yd² (OSY), and any range of coating weights derived from these values. To that end, it should be understood that the desired coating weight of the extrusion coated layers will depend, at least in part, upon the amount of any flame retardants or inorganic fillers in the extrudate.

The extrusion coating melt temperature principally depends on the particular composition of the backing composition being extruded. When using the secondary backing composition describe herein is extruded, the extrusion coating melt temperature can be greater than about 175° C. and, in some aspects, in the range of from 175° C. to 350° C. In another aspect, the melt temperature can be in the range of from 200° C. to 300° C. Alternatively, the melt temperature can be in the range of from 225° C. to 275° C.

In further aspects, the carpet comprises a polymer film disposed on the secondary backing. In some aspects, the polymer film is laminated to the secondary backing. In other aspects, prior to step the film lamination the secondary backing of the preform carpet is heated. In some aspects, this step can be called a preheating step. In certain aspects, the preheating of the secondary backing can be done at a temperature between about 40° C. and about 100° C., including exemplary values of about 45° C., about 50° C., about 55° C., about 60° C., about 65° C., about 70° C., about 75° C., about 80° C., about 85° C., about 90° C., and about 95° C. In some aspects, the lamination can be done at a temperature from about 120° C. to about 200° C., including exemplary values of about 120° C., about 140° C., about 160° C., about 180° C., and about 200° C.

In certain aspects, the gap between two rolls can be any gap commonly utilized by lamination industry. In certain aspects, the gap can be between about 10 mil to about 250 mils, including exemplary values of about 15 mil, about 18 mil, about 20 mil, about 30 mil, about 50 mil, about 60 mil, about 70 mil, about 80 mil, about 90 mil, about 100 mil, about 110 mil, about 120 mil, about 130 mil, about 140 mil, about 150 mil, about 160 mil, about 170 mil, about 180 mil, about 190 mil, about 200 mil, about 210 mil, about 220 mil, about 230 mil, and about 240 mil.

Any known in the art lamination equipment can be used, for example, equipment sold by Union Tool Corporation. An exemplary lamination equipment that can be used is a Union Tool Hot Roll Laminator MD #20962.

In certain aspects, the polymer film can be provided simultaneously with the secondary backing and then co-laminated to the primary backing component. In other aspects, the polymer film is separately disposed on the secondary backing prior to laminating the secondary backing to the greige goods. In these exemplary aspects, the polymer film disposed on the secondary backing and is further co-laminated in such way that the secondary backing is adhered to the back surface of the primary backing component by the adhesive composition, and the polymer film disposed on the secondary backing and wherein a first portion of the polymer film is adhered to the primary backing component and a second portion of the polymer film is adhered to the secondary backing.

The polymer film can be prepared by any techniques known in the art. In some aspects, the polymer film can be extruded. In yet other aspects, the polymer film can be blown. In yet further aspects, the polymer film can be cast. In still further aspects, the polymer film can be engineered to provide desirable characteristics.

One skilled in the art will appreciate that, notwithstanding the particular examples described above, it is contemplated that the carpet composition may be produced by the processes known to those skilled in the art, including but not limited to direct coating and roll metering, and knife-coating and lick-roll application, as described in D. C. Blackly, Latex and Textiles, section 19.4.2, page 361, which is incorporated herein by reference.

In certain aspects, the carpet disclosed herein can be prepared as broad-loomed carpet in rolls typically 6 or 12 feet wide. In some other aspects, broadloom carpet can be prepared in rolls 13′6″ and 15′ feet wide. In still further aspects, the carpet can be 3′×12′ strips, or 24″×24″ tiles, or 9″×36″ tiles.

While the preferred forms of the invention have been disclosed, it will be apparent to those skilled in the art that various changes and modifications may be made that will achieve some of the advantages of the invention without departing from the spirit and scope of the invention. Therefore, the scope of the invention is to be determined solely by the claims to be appended.

### Aspects

In view of the described installation kits and methods and variations thereof, herein below are described certain more particularly described aspects of the inventions. These particularly recited aspects should not however be interpreted to have any limiting effect on any different claims containing different or more general teachings described herein, or that the “particular” aspects are somehow limited in some way other than the inherent meanings of the language and formulas literally used therein.

Aspect 1: A carpet comprising: (a) a greige good comprising: i) a primary backing component having a face surface and a back surface; ii) a plurality of fibers comprising a polyester tufted into the primary backing component such that the plurality of fibers extend from the face surface of the primary backing component and are exposed at the back surface of the primary backing component; and iii) a layer of a hot melt adhesive comprising a polyester on the back surface of the primary backing component, wherein a portion of the plurality of fibers exposed at the back surface of the primary backing component are fused together, wherein the plurality of fibers are bonded to the primary backing by the layer of the hot melt adhesive, wherein the carpet does not comprise a latex precoat layer.

Aspect 2: The carpet of aspect 1, wherein the carpet further comprises a secondary backing having a first surface and a second surface, wherein the first surface of the secondary backing is adhered to the back surface of the primary backing component.

Aspect 3: The carpet of aspect 2, wherein carpet further comprises a polymer film disposed on the second surface of the secondary backing.

Aspect 4: The carpet of any one of aspects 1-3, wherein the layer of the hot melt adhesive is present in an amount from about 1 to about 8 ounces/sq. yard.

Aspect 5: The carpet of any one of aspects 1-3, wherein the layer of the hot melt adhesive is present in an amount from about 2 to about 6 ounces/sq. yard.

Aspect 6: The carpet of any one of aspects 1-3, wherein the layer of the hot melt adhesive is present in an amount from about 2 to about 4 ounces/sq. yard.

Aspect 7: The carpet of any one of aspects 1-6, wherein the hot melt adhesive comprising the polyester has a lower melting temperature than the plurality of fibers comprising the polyester.

Aspect 8: The carpet of any one of aspects 1-7, wherein the primary backing component comprises a polyester.

Aspect 9: The carpet of any one of aspects 1-8, wherein the primary backing component comprises a sheath-core fiber.

Aspect 10: The carpet of any one of aspects 1-9, wherein the secondary backing component comprises a polyester.

Aspect 11: The carpet of any one of aspects 3-10, wherein the polymer film is a fluid barrier.

Aspect 12: The carpet of any one of aspects 3-11, wherein the polymer film is impermeable to gases.

Aspect 13: The carpet of any one of aspects 3-12, wherein the polymer film is a thermoplastic film.

Aspect 14: The carpet of any one of aspects 3-13, wherein the polymer film comprises a polyester.

Aspect 15: The carpet of any one of aspects 3-14, wherein the polymer film has a thickness of less than about 6 mils.

Aspect 16: The carpet of any one of aspects 3-15, wherein the polymer film has a thickness of about 2 to about 4 mils.

Aspect 17: The carpet of any one of aspects 3-15, wherein the polymer film has a thickness of about 1 to about 3 mils.

Aspect 18: The carpet of any one of aspects 3-17, wherein the polymer film is an extruded film.

Aspect 19: The carpet of any one of aspects 3-17, wherein the polymer film is a blown film.

Aspect 20: The carpet of any one of aspects 3-17, wherein the polymer film is a cast film.

Aspect 21: The carpet of any one of aspects 3-17, wherein the polymer film is an engineered film.

Aspect 22: The carpet of any one of aspects 1-21, wherein the carpet comprises at least 80% by weight of polyester.

Aspect 23: The carpet of any one of aspects 1-21, wherein the carpet comprises at least 90% by weight of polyester.

Aspect 24: The carpet of any one of aspects 1-21, wherein the carpet comprises at least 95% by weight of polyester.

Aspect 25: The carpet of any one of aspects 1-21, wherein the carpet comprises at least 99% by weight of polyester.

Aspect 26: A method of making a carpet comprising: (a) providing a greige good comprising: i) a primary backing component having a face surface and a back surface; ii) a plurality of fibers comprising a polyester tufted into the primary backing component such that the plurality of fibers extend from the face surface of the primary backing component and are exposed at the back surface of the primary backing component; and iii) a layer of a hot melt adhesive comprising a polyester on the back surface of the primary backing component, (b) applying a sufficient amount of heat to the greige good, thereby: i) fusing together a portion of the plurality of fibers exposed at the back surface of the primary backing component; and ii) melting the hot melt adhesive comprising the polyester to bond the plurality of fibers to the primary backing component by the hot melt adhesive, wherein the carpet does not comprise a latex precoat layer.

Aspect 27: A method of making a carpet comprising: a) providing primary backing component having a face surface and a back surface; b) applying a layer of a hot melt adhesive comprising a polyester on the back surface of the primary backing component; c) after the step of applying the layer of the hot melt adhesive comprising the polyester to the primary backing, tufting a plurality of fibers comprising a polyester through the primary backing such that the plurality of fibers extend from the face surface of the primary backing component and are exposed at the back surface of the primary backing component, thereby producing a greige good; and d) applying a sufficient amount of heat to the greige good, thereby i) fusing together a portion of the plurality of fibers exposed at the back surface of the primary backing component; and ii) melting the hot melt adhesive comprising the polyester to bond the plurality of fibers to the primary backing component by the hot melt adhesive, wherein the carpet does not comprise a latex precoat layer.

Aspect 28: The method of aspects 26-27, wherein applying a sufficient amount of heat to the greige good comprises applying heat using a drum.

Aspect 29: The method of any one of aspects 26-28, wherein applying the sufficient amount of heat to the greige good causes the portion of the plurality of fibers exposed at the back surface of the primary backing component to soften but not melt.

Aspect 30: The method of any one of aspects 26-29, wherein the layer of the hot melt adhesive comprising the polyester is applied in an amount from about 1 to about 8 ounces/sq. yard.

Aspect 31: The method of any one of aspects 26-29, wherein the layer of the hot melt adhesive comprising the polyester is applied in an amount from about 2 to about 6 ounces/sq. yard.

Aspect 32: The method of any one of aspects 26-29, wherein the layer of the hot melt adhesive comprising the polyester is applied in an amount from about 2 to about 4 ounces/sq. yard.

Aspect 33: The method of any one of aspects 26-32, wherein the method further comprises adhering a secondary backing to the back surface of the primary backing component.

Aspect 34: The method of aspect 33, wherein the adhering a secondary backing to the back surface of the primary backing component comprises laminating the secondary backing to the back surface of the primary backing component.

Aspect 35: The method of aspects 33-34, wherein the method further comprises adhering a polymer film to the secondary backing.

Aspect 36: The method of any one of aspects 33-35, adhering the polymer film to the secondary backing comprises laminating the polymer film to the secondary backing.

Aspect 37: The method of any one of aspects 26-36, wherein the primary backing component comprises a polyester.

Aspect 38: The method of any one of aspects 26-37, wherein the primary backing component comprises a sheath-core fiber.

Aspect 39: The method of any one of aspects 33-38, wherein the secondary backing component comprises a polyester.

Aspect 40: The method of any one of aspects 35-39, wherein the polymer film is a fluid barrier.

Aspect 41: The method of any one of aspects 35-40, wherein the polymer film is impermeable to gases.

Aspect 42: The method of any one of aspects 35-41, wherein the polymer film is a thermoplastic film.

Aspect 43: The method of any one of aspects 35-42, wherein the polymer film comprises a polyester.

Aspect 44: The method of any one of aspects 35-43, wherein the polymer film has a thickness of less than about 6 mils.

Aspect 45: The method of any one of aspects 35-44, wherein the polymer film has a thickness of about 2 to about 4 mils.

Aspect 46: The method of any one of aspects 35-44, wherein the polymer film has a thickness of about 1 to about 3 mils.

Aspect 47: The method of any one of aspects 35-46, wherein adhering the polymer film to the secondary backing comprises extruding the polymer film onto the secondary backing.

Aspect 48: The method of any one of aspects 35-47, wherein adhering the polymer film to the secondary backing comprises blowing the polymer film onto the secondary backing.

Aspect 49: The method of any one of aspects 35-48, wherein adhering the polymer film to the secondary backing comprises casting the polymer film onto the secondary backing.

Aspect 50: The method of any one of aspects 35-49, wherein the polymer film is an engineered film.

Aspect 51: The method of any one of aspects 26-50, wherein the carpet comprises at least 80% by weight of polyester.

Aspect 52: The method of any one of aspects 26-50, wherein the carpet comprises at least 90% by weight of polyester.

Aspect 53: The method of any one of aspects 26-50, wherein the carpet comprises at least 95% by weight of polyester.

Aspect 54: The method of any one of aspects 26-50, wherein the carpet comprises at least 99% by weight of polyester.

### Examples

The following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

Samples 1.1-4.6 were produced as follows: Samples were made at Shaw development labs in Dalton, Ga. and Cartersville, Ga. A primary backing was coated with a hot melt adhesive, which structure was tufted with fibers. Wear and performance data were obtained from conventional testing methods. Several samples were created with several variations in hot melt adhesives and coating weight, as listed in Table I. The samples were then processed on a laboratory scale using a fusing drum, as described herein. The processing data and performance results are also shown in Table I.

As described herein, in some aspects to determine the wet and/or dry strength, the Tuft Bind Test according to ASTM D-1335 is used. The Tuft Bind Test determines the amount of force that is necessary to pull the yarn from its primary backing. It is desirable to obtain carpets with highest tuft bind values possible. It is understood that the carpet that withstands a high amount of force lasts longer, and the original appearance is preserved due to fewer snags.

The strength of the inventive carpet compositions was measured by the Velcro® (“Velcro”) test. The Velcro test utilizes a Velcro tester to measure the carpet composition strength. Velcro is a registered trademark for the well-known hook and loop fastening material. In the Velcro test, a two pound roller approximately three-and-a-half inches wide and one-and-a-half inches in diameter coated with Velcro hook material is rolled repeatedly over the loop pile carpet, for example, ten times. The carpet is then inspected for protruding fibers or fuzz. By “fuzzy,” it is meant short, individual filaments (often 1-3 stitch lengths long) removed from fiber bundles. The results are rated on a scale 1 to 4, with 4 being the best results. A rating of at least 3 is preferable for Velcro. The results are shown in Table 1.

TABLE 1

| | Griltex Hotmelt | Coating Wts, | Roller Set | Roller Actual | Contact |
|---|---|---|---|---|---|
| Sample | used | oz/sq.yd. | Temp, C. | Temp, C. | time, sec |
| 1.1 | D 1573E | 2.0 | 282 | 263 | 13 |
| 1.2 | D 1573E | 2.0 | 282 | 264 | 14 |
| 1.3 | D 1573E | 3.9 | 282 | 262 | 13 |
| 1.4 | D 1573E | 3.9 | 282 | 262 | 14 |
| 2.1 | D 1573E | Transition | 282 | 264 | 12 |
| 2.2 | D 1573E | Transition | 282 | 264 | 15 |
| 3.1 | D 1573E | 1.2 | 282 | 264 | 12 |
| 3.2 | D 1573E | 1.2 | 282 | 264 | 15 |
| 3.3 | D 1573E | 1.2 | 282 | 262 | 13 |
| 4.1 | 6 E GF | 1.8 | 282 | 263 | 13 |
| 4.2 | 6 E GF | 1.8 | 282 | 262 | 14 |
| 4.3 | 6 E GF | 2.3 | 282 | 262 | 13 |
| 4.4 | 6 E GF | 2.3 | 282 | 262 | 14 |
| 4.5 | 6 E GF | 3.16 | 282 | 262 | 13 |
| 4.6 | 6 E GF | 3.16 | 282 | 262 | 14 |

TABLE 1 CONT.

| | | | Warp Velcro | Fill Velcro | Tuft Bind | Tuft Bind |
|---|---|---|---|---|---|---|
| | | pressure, | 3-OK | 3-OK | Loop | Cut Pile |
| Sample | gap, mm | bar | 4+-Good | 4+-good | (Min - 6.25) | (Min - 3.0) |
| 1.1 | 0.8 | 3 | 2 | 2 | 8.87 | 3.92 |
| 1.2 | 0.8 | 3 | 2 | 2 | 4.89 | 3.51 |
| 1.3 | 0.8 | 3 | 4 | 4 | 15.14 | 4.88 |
| 1.4 | 0.8 | 3 | 4 | 4 | 14 | 4.76 |
| 2.1 | 0.8 | 3 | 3 (Fuzzy) | 3 (Fuzzy) | 5.83 | 3.39 |
| 2.2 | 0.8 | 3 | 2 | 2 | 4.42 | 2.56 |
| 3.1 | 0.8 | 3 | 2 (Fuzzy) | 2 (Fuzzy) | 3.49 | 3.25 |
| 3.2 | 0.8 | 3 | 3 | 3 | 6.17 | 3.06 |
| 3.3 | 0.8 | 3 | 3 | 3 | 6.6 | 3.94 |
| 4.1 | 0.8 | 3 | 2 | 2 | 6.67 | 3.19 |
| 4.2 | 0.8 | 3 | 3 | 3 | 6.73 | 3.82 |
| 4.3 | 0.8 | 3 | 2 | 2 | 8.84 | 3.67 |
| 4.4 | 0.8 | 3 | 2 | 2 | 9.03 | 3.72 |
| 4.5 | 0.8 | 3 | 2 | 2 | 8.9 | 4.72 |
| 4.6 | 0.8 | 3 | 2 | 2 | 7.53 | 4.05 |

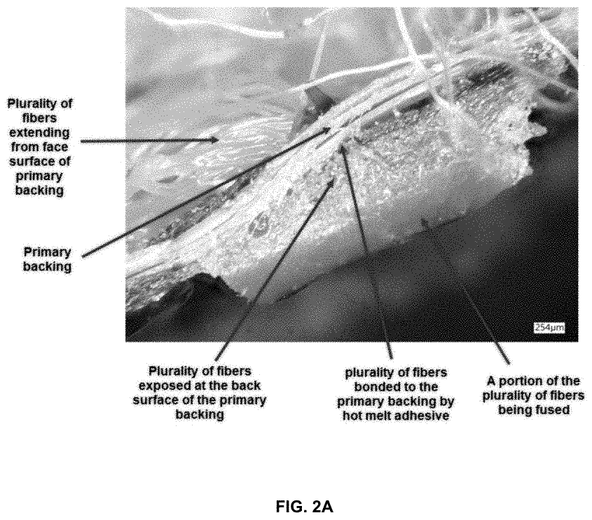

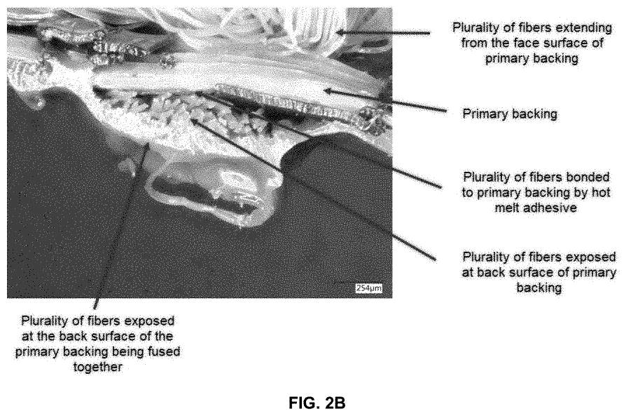

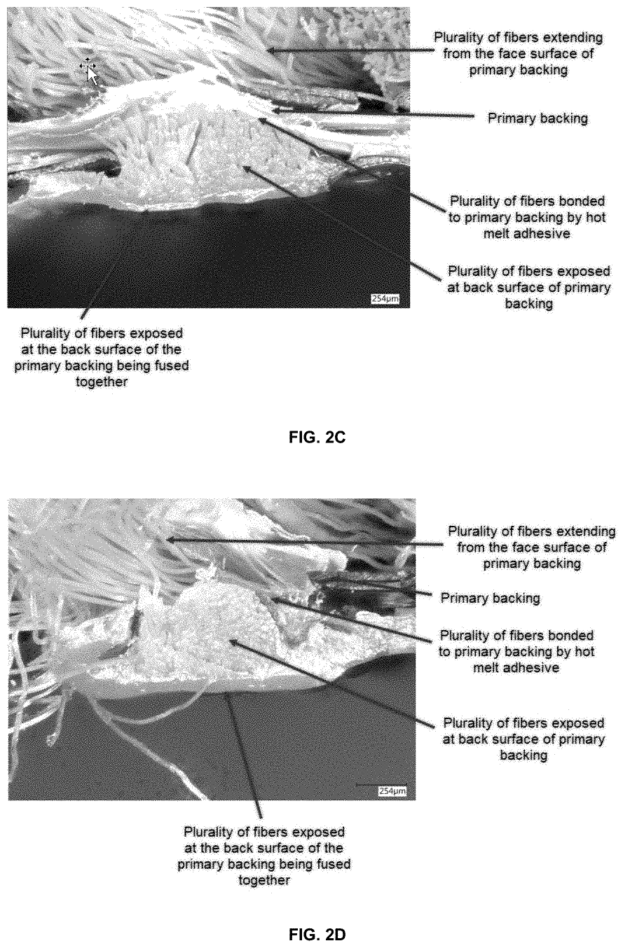

FIG. 2A shows a photograph example 1.3 of Table 1, which passed the Velcro test, and the tuft bind tests. The photograph of the carpet sample shown in FIG. 2A has five portions as indicated by the arrows, as follows: 1) portion of a plurality of fibers extending from a face surface of a primary backing; 2) a portion of a primary backing; 3) a portion of a plurality of fibers exposed at the back surface of the primary backing; 4) a portion of a plurality of fibers bonded to the primary backing by a hot melt adhesive; and 5) a portion of the plurality of fibers being fused.

FIG. 2B shows a photograph example 3.2 of Table 1, which passed the Velcro test, and the tuft bind tests. The photograph of the carpet sample shown in FIG. 2B has five portions as indicated by the arrows, as follows: 1) portion of a plurality of fibers extending from a face surface of a primary backing; 2) a portion of a primary backing; 3) a portion of a plurality of fibers exposed at the back surface of the primary backing; 4) a portion of a plurality of fibers bonded to the primary backing by a hot melt adhesive; and 5) a portion of the plurality of fibers exposed at the back surface of the primary backing being fused together.

FIG. 2C shows a photograph example 3.3 of Table 1, which passed the Velcro test, and the tuft bind tests. The photograph of the carpet sample shown in FIG. 2C has five portions as indicated by the arrows, as follows: 1) portion of a plurality of fibers extending from a face surface of a primary backing; 2) a portion of a primary backing; 3) a portion of a plurality of fibers exposed at the back surface of the primary backing; 4) a portion of a plurality of fibers bonded to the primary backing by a hot melt adhesive; and 5) a portion of the plurality of fibers exposed at the back surface of the primary backing being fused together.

FIG. 2D shows a photograph example 4.2 of Table 1, which passed the Velcro test, and the tuft bind tests. The photograph of the carpet sample shown in FIG. 2D has five portions as indicated by the arrows, as follows: 1) portion of a plurality of fibers extending from a face surface of a primary backing; 2) a portion of a primary backing; 3) a portion of a plurality of fibers exposed at the back surface of the primary backing; 4) a portion of a plurality of fibers bonded to the primary backing by a hot melt adhesive; and 5) a portion of the plurality of fibers exposed at the back surface of the primary backing being fused together.

1. A carpet comprising:
(a) a greige good comprising:
i) a primary backing component having a face surface and a back surface;
ii) a plurality of fibers comprising a polyester tufted into the primary backing component such that the plurality of fibers extend from the face surface of the primary backing component and are exposed at the back surface of the primary backing component; and
iii) a layer of a hot melt adhesive comprising a polyester on the back surface of the primary backing component,
wherein a portion of the plurality of fibers exposed at the back surface of the primary backing component are fused together,
wherein the plurality of fibers are bonded to the primary backing by the layer of the hot melt adhesive,
wherein the carpet does not comprise a latex precoat layer.

2. The carpet of claim 1, wherein the carpet further comprises a secondary backing having a first surface and a second surface, wherein the first surface of the secondary backing is adhered to the back surface of the primary backing component.

3. The carpet of claim 2, wherein carpet further comprises a polymer film disposed on the second surface of the secondary backing.

4. The carpet of claim 1, wherein the layer of the hot melt adhesive is present in an amount from about 1 to about 8 ounces/sq. yard.

5. The carpet of claim 1, wherein the hot melt adhesive comprising the polyester has a lower melting temperature than the plurality of fibers comprising the polyester.

6. The carpet of claim 1, wherein the primary backing component comprises a polyester.

7. The carpet of claim 1, wherein the primary backing component comprises a sheath-core fiber.

8. The carpet of claim 1, wherein the secondary backing component comprises a polyester.

9. The carpet of claim 3, wherein the polymer film comprises a polyester.

10. The carpet of claim 3, wherein the polymer film has a thickness of less than about 6 mils.

11. The carpet of claim 3, wherein the polymer film is an engineered film.

12. The carpet of claim 1, wherein the carpet comprises at least 95% by weight of polyester.

13. The carpet of claim 1, wherein the carpet comprises at least 99% by weight of polyester.

14. A method of making a carpet comprising:
(a) providing a greige good comprising:
a. a primary backing component having a face surface and a back surface;
b. a plurality of fibers comprising a polyester tufted into the primary backing component such that the plurality of fibers extend from the face surface of the primary backing component and are exposed at the back surface of the primary backing component; and
c. a layer of a hot melt adhesive comprising a polyester on the back surface of the primary backing component,
(b) applying a sufficient amount of heat to the greige good, thereby:
a. fusing together a portion of the plurality of fibers exposed at the back surface of the primary backing component; and
b. melting the hot melt adhesive comprising the polyester to bond the plurality of fibers to the primary backing component by the hot melt adhesive,
wherein the carpet does not comprise a latex precoat layer.

15. A method of making a carpet comprising:
a) providing primary backing component having a face surface and a back surface;
b) applying a layer of a hot melt adhesive comprising a polyester on the back surface of the primary backing component;
c) after the step of applying the layer of the hot melt adhesive comprising the polyester to the primary backing, tufting a plurality of fibers comprising a polyester through the primary backing such that the plurality of fibers extend from the face surface of the primary backing component and are exposed at the back surface of the primary backing component, thereby producing a greige good; and
d) applying a sufficient amount of heat to the greige good, thereby
i) fusing together a portion of the plurality of fibers exposed at the back surface of the primary backing component; and
ii) melting the hot melt adhesive comprising the polyester to bond the plurality of fibers to the primary backing component by the hot melt adhesive,
wherein the carpet does not comprise a latex precoat layer.

16. The method of claim 14, wherein applying a sufficient amount of heat to the greige good comprises applying heat using a drum.

17. The method of claim 14, wherein applying the sufficient amount of heat to the greige good causes the portion of the plurality of fibers exposed at the back surface of the primary backing component to soften but not melt.

18. The method of claim 14, wherein the layer of the hot melt adhesive comprising the polyester is applied in an amount from about 1 to about 8 ounces/sq. yard.

19. The method of claim 14, wherein the method further comprises adhering a secondary backing to the back surface of the primary backing component.

20. The method of claim 19, wherein the method further comprises adhering a polymer film to the secondary backing.

21. The method of claim 14, wherein the primary backing component comprises a polyester.

22. The method of claim 19, wherein the secondary backing component comprises a polyester.

23. The method of claim 20, wherein the polymer film comprises a polyester.

24. The method of claim 20, wherein the polymer film has a thickness of less than about 6 mils.

25. The method of claim 20, wherein the polymer film is an engineered film.

26. The method of claim 14, wherein the carpet comprises at least 95% by weight of polyester.

27. The method of claim 14, wherein the carpet comprises at least 99% by weight of polyester.

28. The method of claim 15, wherein step b) comprises directly melting the hot melt adhesive on the back surface of the primary backing component or applying a film of the hot melt adhesive on the back surface of the primary backing component.
